(19) United States
(12) Patent Application Publication
(10) Pub. No.: US 2012/0118591 A1
(43) Pub. Date: May 17, 2012

(54) Water, foam and compressed air protection against fire, in or associated with structures

(76) Inventor: Ping-Li Yen, Arcadia, CA (US)

(21) Appl. No.: 12/927,303

(22) Filed: Nov. 12, 2010

(51) Int. Cl. A62C 3/00; A62C 35/64; A62C 35/68; A62C 31/00

(52) U.S. Cl. 169/47; 169/13

(57) ABSTRACT

The method of suppressing fire in a structure, that includes providing a motor driven air compressor and water pump fixed position system operable to produce a pressurized source of fluid flow including water, foam and compressed air, installing an elongated duct or ducts to extend in fixed position or positions to a source fluid delivery location or locations at or within that structure, installing a fire or smoke detector or detectors at or within the structure, to produce a signal or signals in response to fire detection at or near the monitoring detector or detectors, and operating the system to deliver the fluid to the duct or ducts to be accurately and controllably delivered to a location or locations, in response to a detector signal or signals, for suppressing the fire, as via different nozzles to which fluid is controllably delivered.

### BACKGROUND OF THE INVENTION

This invention relates generally to fire fighting and prevention, and more particularly concerns method and apparatus to efficiently and automatically fight and prevent fires in or in association with structures such as buildings and other spaces, by employment of fluid including water, foam and compressed air.

There is constant need for improvements in method and apparatus to fight and/or prevent fires in or at such fixed structures and spaces, including buildings, such as high rise buildings, hangers, oil tank farms, cargo loading and unloading spaces, airports, sea ports, as well as many other types of industrial spaces and structures. There is also need for the unusually effective automatically responsive methods and apparatus to quickly and accurately

### SUMMARY OF THE INVENTION

It is a major object of the invention to provide method and apparatus to meet the above needs. Basically, the method of the invention includes the following steps:

a) providing a fixed position system operable to provide a pressurized source of fluid flow including water, foam and compressed air,

b) installing an elongated fixed position duct or ducts to extend to a source fluid delivery location or locations at or within a fixed structure, as for example a large building,

c) installing a fire or smoke detector or detectors at different locations at or within that structure, to produce a control signal or signals in response to fire or smoke detection at or near the detector or detectors,

d) and operating the system to deliver such fluid to the duct or ducts to be accurately delivered to said location or locations, in response to said signal or signals, for suppressing the fire,

e) such operating including increasing or decreasing pressurized water and foam delivery in response to automatically detected changes in fire extent or extents at said location or locations.

As will be seen, the method may typically include providing a motor driven pump means, and air compressor means, operable to produce such fluid, and a fixed power source for said means, the power source operated in response to the detector signal or signals. Also, the ducting or ducts may include a nozzle or nozzles configured to provide a fluid spray delivery at the elevated location of the nozzle or nozzles in or outside, or in association with the structure. Such ducts may include control valves to automatically or manually control fluid accurate delivery at controlled rates to the selected or different spray nozzles; at the fire or smoke location or locations, and connections for attachment of fire hoses may be provided.

Representative locations subject to fire risk may include:
i) building, such as a high rise building
ii) tunnel
iii) subway station
iv) electrical power generator apparatus
v) electrical transformer apparatus
vi) other public accessible structure
vii) tank farms.

The detectors may be spacially associated with the duct outlets or nozzles, enabling quick and accurate delivery, in response to detector sensing of fire, excessive heat, or smoke, at or near selected zones, in or on, or associated with structures as referred to, and particularly at different elevations or locations proximate to or in such structures. Typically, the structure may have different zones, as at different floor levels, and the detectors are installed at or near such zones, there being fluid delivery outlets at or near said zones.

A further object is to provide apparatus for use in the method or methods referred to.

These and other objects and advantages of the invention, as well as the details of an illustrative embodiment, will be more fully understood from the following specification and drawings, in which:

### DRAWING DESCRIPTION

FIG. 1 is an elevation showing one form of the invention, and which is preferred;

FIG. 2 is an elevation showing another form of the invention;

FIG. 3 is a detailed system block diagram; and

FIG. 4 shows a tank farm to be fire protected.

### DETAILED DESCRIPTION

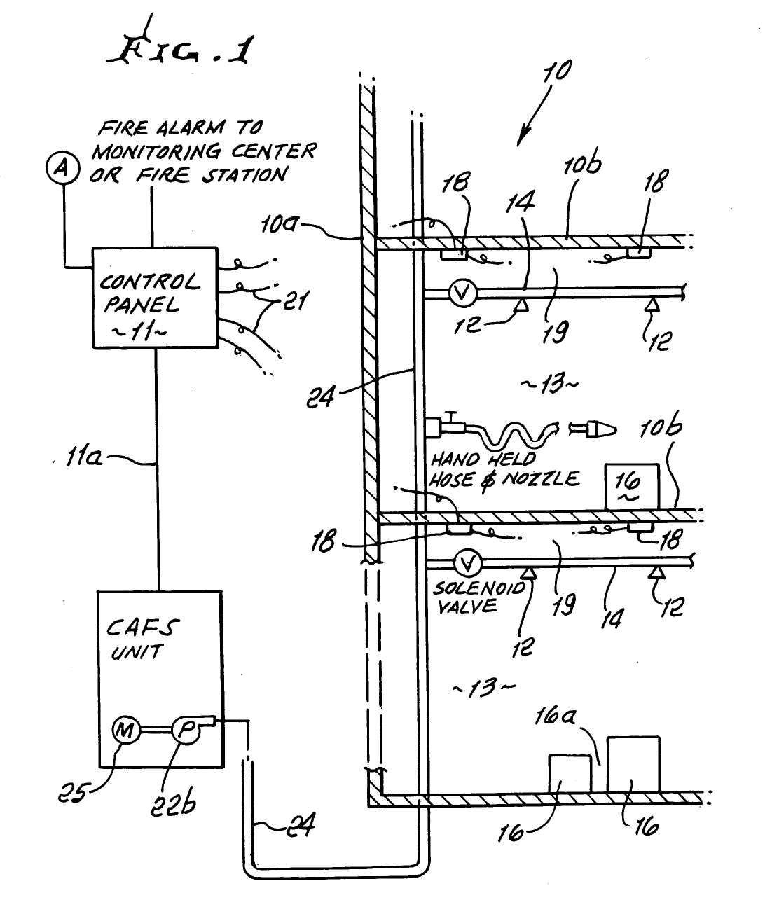

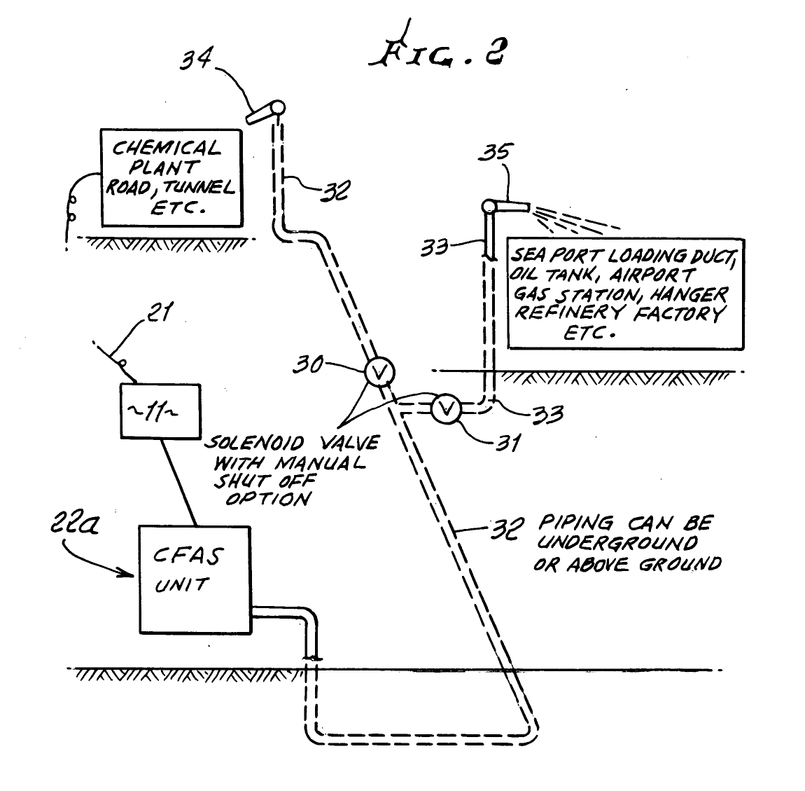

In FIG. 1 a structure is shown, in the form of a building 10 such as a high rise building, having a vertical wall 10a and several or many horizontal floors 10b at different elevations. A control unit 11 or control panel is located inside or outside the building, or at other location, to control dispensing of fluid, as from nozzles 12 located at interior zones or areas 13 within the building and at different elevations, as between floor levels, and at different and controlled rates. Such fluid consists of a pressurized mix of foam, water and compressed air, to be dispensed in heavy spray form, typically in overlapping spray pattern form. For example, the nozzles are located at positions along ducts or pipes 14 extending horizontally at upper levels in the zones 13, as for example at locations close to the undersides of the horizontal floors 10b. The nozzles and ducts 14 may be openly exposed, as in a warehouse for containers or goods 16. Fire may break out in or near 16 or in the zones 13, for unknown reasons, and it is a purpose of the invention to automatically and immediately detect any such fire, or smoke, and to immediately and controllably spray such fluid into that zone 13 where the fire occurs, substantially to engulf fire in the zone and the spaces 16a around the containers or goods, stopping such fire.

For the above purposes, fire detectors, such as heat detectors 18 are positioned at intervals throughout the upper interior 19 of the spaces or zones 13 and 16a to which hot gas and air rises. See the detectors located above the ducting 14, and adjacent the undersides of the flooring, to which heat rises whereby the detectors are protected by foam and water particles sprayed or dispensed downwardly from the nozzles 12 carried by the ducting 14 below the detectors. In this way, fire at the lower interior levels of the zones 13 is detected and suppressed before fire related damaging of the detectors occurs, enabling later use of the detectors after a fire breakout and suppression event.

The heat detectors provide electrical signals transmitted by wires 21 to a control unit 11 associated with a means 22a that is activated at 11a by unit 11 to pump fluid under pressure to ducts 24 leading to and communicating with horizontal ducts or piping 14. The means 22a typically includes a water pump or pumps 22b and a pump motor 25 activated in response to detector signals, as via control unit 11 controlling valves in ducts to provide differential rates of flow to the duct nozzles for most efficient fire suppression. In this way, a mix of foam and water driven by compressed air, is produced or locally provided only at the time of fire detection, and only to zones 13 associated with local fire, so that minimum damage to the goods or containers, or to the building interior, or to valves or detectors, occurs. Also, supply of such fluid in or to the relevant building zone continues until the detected temperature level at that zone falls below a pre-set level, for maximum protection against fire and water damage. If fire breaks out again, the detector or detectors effect resumption of controlled fluid delivery from the relevant nozzles. Delivery of fluid may be effected via different fixed position pipes, and selectively, to different floors or zones, and/or to different zones at each floor level or distributed horizontally, whereby only those zones where fire occurs are sprayed with fire suppressive fluid. This selective control of fluid delivery may be under the control of unit 11, whereby if fire breaks out at zone x₁ where there are zones x₁, x₂, x₃ . . . xₙ, located on a floor Y₂ where the building contains floors Y₁, Y₂, Y₃ . . . Yₙ, only zone x₁ on floor Y₂ will be sprayed with fluid; and if the fire spreads to zone x₂ on floor Y₂, both such zones and no others will be controllably automatically sprayed as by overlapping spray patterns from successive nozzles, until detected temperatures at such zone or zones fall below the preset level or levels. In this regard, the pump or pumps will be motor energized to provide the needed fluid pressure at nozzles associated with the zone or zones at which fire is detected, as via control unit 11, and unit 22a.

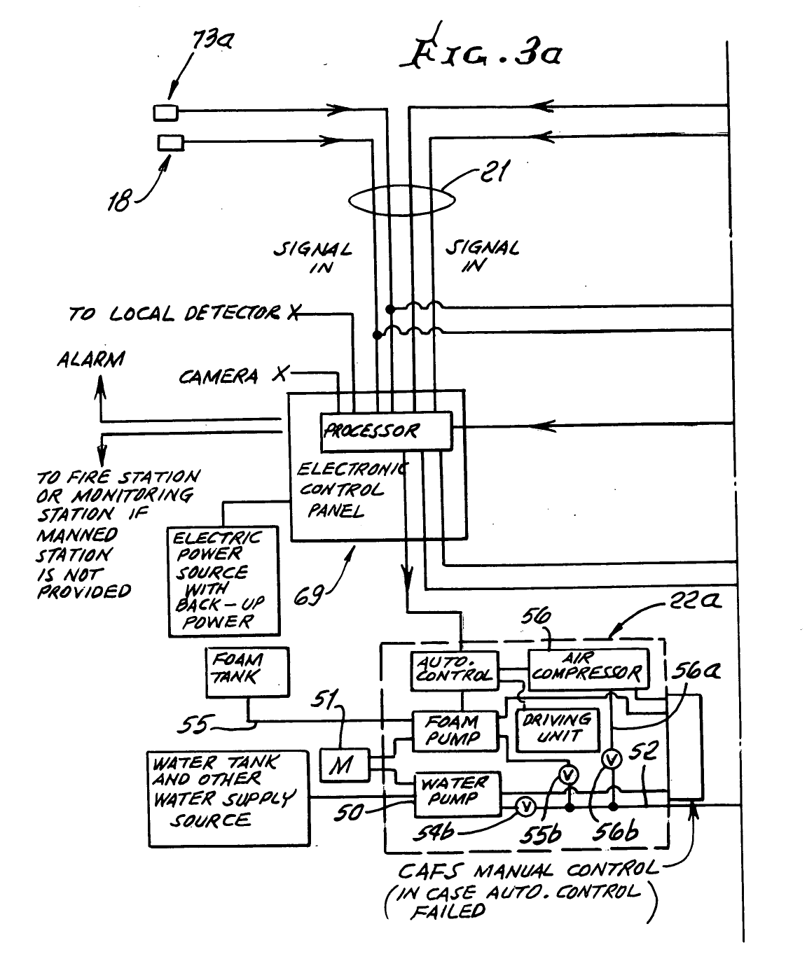

Referring now to FIG. 2, the elements are the same as in FIG. 1. Also provided are valves 30 and 31 located in fluid supply ducts 32 and 33 whereby fluid pressure supply to different ducts may be controlled. If fluid is needed at nozzles 34 along duct 32, but not needed at nozzles 35 along duct 33, valve 31 in duct 33 is closed, manually, or automatically, as via solenoid control, for example.

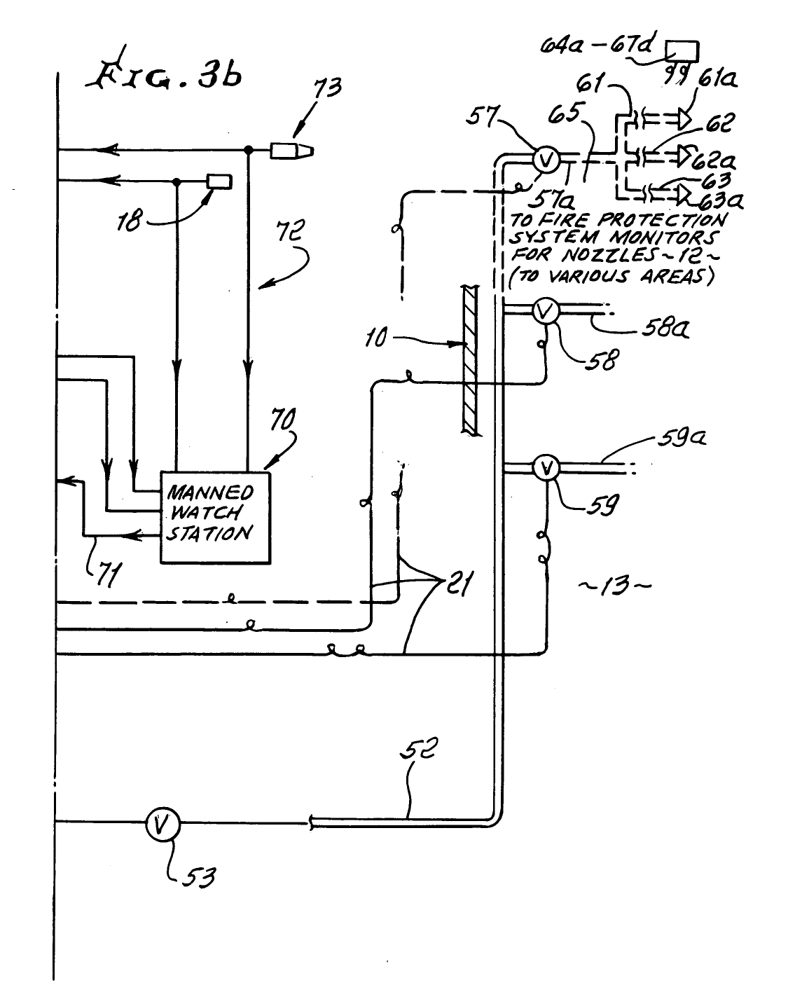

FIG. 3 shows a system incorporating the invention. Pump 50, driven by motor 51, drives the fluid mix to a supply duct 52, extending horizontally, and/or vertically, via a master ON-OFF valve 53. The pump intake consists of water 54, foam 55 or foamable substance, and compressed air at 56 is delivered at 56a. Motor 51 may also drive an air compressor 56a. Controls for supplies 54, 55 and 56 are indicated at 54b, 55b and 56b. Valves 57, 58 and 59 in ducts 57a, 58a and 59a control fluid flow to different building floor levels, or other different buildings or areas as shown. At each floor level, there may be sub-ducts or pipes, as at 61-63 for example extending to different zones at that floor level, the sub-ducts terminating at nozzles 61a-63a. Valves in the sub-ducts control flow to the nozzles. Detectors 64d-67d at each zone detect fire at that zone and signal such detectors to master control unit 69.

For example, if fire is detected at a zone 65, by detector 64d, the control unit is signaled and operates to effect pumping or delivery of the fluid mix to duct 57a, via valve 57, to spray fluid at controlled rate only to and into zone 65, suppressing fire in that zone.

Like groups of zones, sub-ducts, nozzles and detectors are associated with ducts 58a and 59a, as shown.

In addition a control station 70 typically manned by an individual, is connected at 71 to panel 69. Station 70 receives input at 72 from cameras 73 and/or infra-red fire or flame detection cameras 73a, positioned at or near detector locations in or in association with structure 10. These are monitoring cameras, that supplement the fire detectors 18, as in FIG. 1. This provides double protection against fire, and damage due to fire and water.

The station 70 operator can quickly visually scan zones 13 of the structures, to determine what zones (say, above or below a zone where fire occurs) should be sprayed with the compressed air, foam and water mix, and then sprayed, at controlled rate, or rates to different zones, for assured protection.

The production of compressed air foam (CAF) may be by known methods. See in this regard disclosed NFPA 11 Standard for Low-, Medium-, and High-Expansion Foam, incorporated herein by reference.

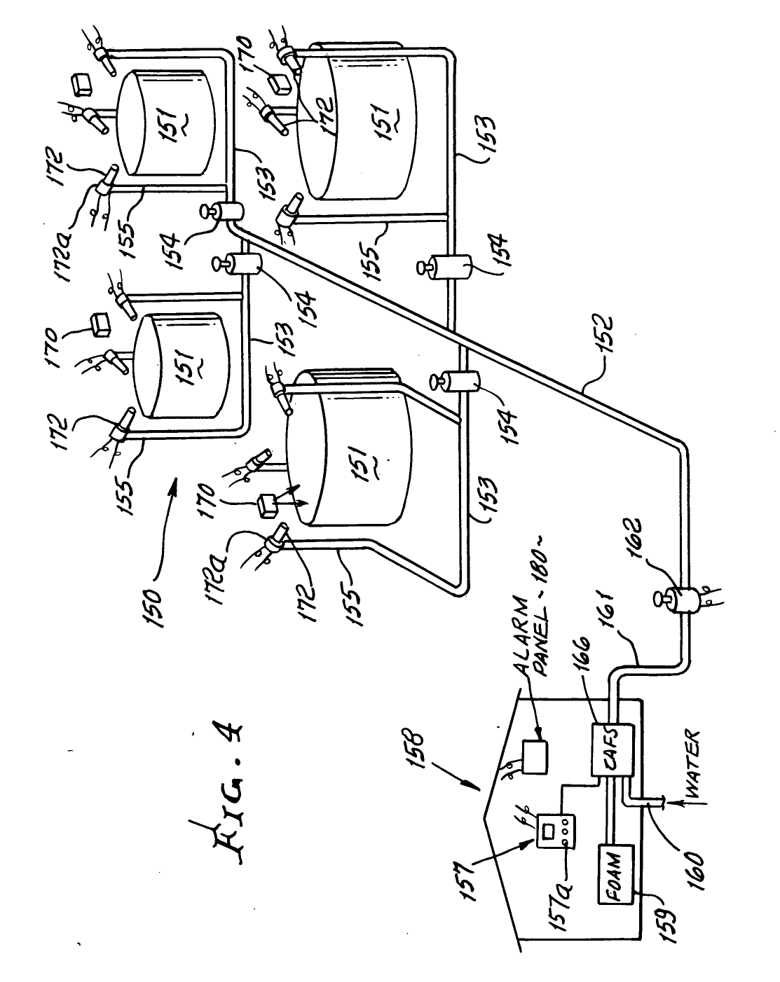

FIG. 4 shows a tank farm 150, with multiple tanks 151 distributed or separated horizontally apart. Horizontally extending piping 152 extends above or below ground to deliver fluid including compressed air, foam and water to branch pipes 153, via control valves 154. Riser pipe 155 receives such fluid for flow to nozzles 172 individually controlled to spray such fire suppressing fluid onto the tanks at which fire has occurred. One of more nozzles 172 are mounted to be individually driven to controllably swing relative to the riser pipes and associated tanks, to distribute fire suppressing fluid (compressed air, water, and foam mix) over the tanks, or to tank areas where fire has broken out. A nozzle control is shown at 172a, and is electrically connected to control panel 157 operated at 157a, at remote station 158.

Station 158 may also serve as an operating location for controllable delivery of foam from tank 159, and water at 160, to CAFS apparatus 166 controllably delivering pressurized fluid to piping 161 connected to piping 152. A master control valve in 162 is manually or solenoid controlled, as from panel 157.

Valves 162 and 154 may be solenoid operated, and controlled as from panel 157, manually or automatically as in response to sensor or camera detection of fire at a tank. See sensors and/or scanning cameras 170. Nozzles 172 connected to user pipes 155 are driven and/or controlled, to swing back and forth in place during fluid spraying, and valves at the nozzles may be controlled, from 157 to individually increase or decrease the flow of compressed air, foam and water. The corners transmit visually, conditions at the tanks, to video screen 157b. Similar control systems maybe used at other structures as referred to.

I claim:

1. The method of suppressing fire in a structure, that includes:
a) providing a fixed position motor driven air compressor and water pump system operable to produce a pressurized source of fluid flow including water, foam and compressed air,
b) installing a fixed position elongated duct or ducts to extend to a source fluid delivery location or locations at or with that structure,
c) installing a fire or smoke detector or detectors at or within said structure, to produce a control signal or signals in response to fire detection at or near the detector or detectors,
d) and operating said system to deliver said fluid to said duct or ducts to be accurately delivered to said location or locations, in response to said signal or signals, for suppressing the fire,
e) said operating including increasing or decreasing pressurized water and foam delivery in response to automatically detected changes in fire extent or extents at said location or locations.

2. The method of claim 1 wherein said duct or ducts extend to different elevations in the structure.

3. The method of claim 1 including providing a water pump means, and an air compressor means operable to produce said fluid, and a power source for said means, said power source operated in response to said signal or signals.

4. The method of claim 1 wherein said ducts include a nozzle configured to provide a fluid spray delivery at the elevated location of the nozzle in the structure.

5. The method of claim 1 wherein said duct or ducts includes outlets at different elevations in the structure, and control valves to control fluid delivery at controlled rates, at selected outlets.

6. The method of claim 5 including providing connections at said outlets for attachment of fire hoses.

7. The method of claim 1 wherein the duct or ducts extend from said source to said location or locations, which include one or more of the following:
i) building
ii) tunnel
iii) subway station
iv) electrical power generator apparatus
v) electrical transformer apparatus
vi) other public accessible structure.

8. The method of claim 2 wherein the structure has different zones, and said detectors are installed at or near said zones, there being fluid delivery outlets at or near said zones.

9. The method of claim 8 wherein said detectors are associated with said outlets, which comprise spray nozzles, at different of said zones, there being a control station operatively connected to said detectors, and to control valves in said ducts to be responsive to fire detecting operation of the detectors to differentially control flow to the nozzles, for efficient suppression of fire.

10. Apparatus for suppressing fire in a structure or structures, that includes, in combination:
a) a motor driven air compressor and water pump system operable to provide a pressurized source of fluid including water, foam and compressed air for dispensing at or within said structure or structures,
b) a fixed position duct or ducts extending to a source fluid delivery location or locations at, or within said structure or structures, and to nozzles at said location or locations,
c) a fire or smoke fixed position detector or detectors installed at or within said structure or structures, to produce a signal or signals in response to fire detection at or near said detector or detectors,
d) control means responsive to said signal or signals to control rates of fluid flow to a selected duct or ducts and nozzles to suppress fire at said location or locations,
e) and means operable to deliver said fluid to said duct or ducts to be delivered to said location or locations, in response to said signal or signals.

11. The combination of claim 10 wherein said duct or ducts extend in fixed position to different elevations in the structure.

12. The combination of claim 10 wherein said system is operable to produce said fluid, and including a power source for said system, said power source operated in response to said signal or signals.

13. The combination of claim 10 wherein said duct includes a nozzle configured to provide a fluid mist delivery at the elevated location of the nozzle in the structure.

14. The combination of claim 10 wherein said duct or ducts extend to a fluid delivery location or locations at, or within different zones in said building.

15. The combination of claim 10 wherein said ducts have outlets that include connections for attachment of fire hoses.

16. The combination of claim 10 wherein said locations include one or more of the following:
i) building
ii) tunnel
iii) subway station
iv) electrical power generator apparatus
v) electrical transformer apparatus
vi) other public accessible structure
vii) tank farm.

17. The method of claim 1 including providing cameras within or in association with the structure operable to enable remote visual observation of fire or smoke, enabling additional control and controlled delivery of compressed air, foam and water mix to selected locations associated with said observed fire or smoke.

18. The method of claim 17 wherein the cameras are operated for visual detection of the status of different elevation locations in the building or structure, above or below a fire occurrence location, and controlling fluid mix delivery to said different locations.

19. The combination of claim 10, including visual detection means within the structure operating to provide remote visual detection of fire or smoke, enabling supplemental control and delivery of compressed air, foam and water, to selected locations.

20. The combination of claim 10 wherein said structure or structures comprises a tank farm including multiple separated tanks, to which fixed position ducts as defined extend, above or below ground.

21. The combination of claim 14 wherein detectors in said zones are located above levels of fixed position ducts and nozzles in said zones.
